(19) United States
(12) Patent Application Publication
(10) Pub. No.: US 2013/0059151 A1
(43) Pub. Date: Mar. 7, 2013

(54) MAGNESIUM OXIDE FOR PHARMACEUTICAL PREPARATION

(71) Applicants: Masashi Konishi, Naruto-shi (JP); Shouichi Oonishi, Naruto-shi (JP); Akira Ookubo, Naruto-shi (JP); Masashi Yunoki, Naruto-shi (JP); Ariumi Kawamoto, Naruto-shi (JP)

(72) Inventors: Masashi Konishi, Naruto-shi (JP); Shouichi Oonishi, Naruto-shi (JP); Akira Ookubo, Naruto-shi (JP); Masashi Yunoki, Naruto-shi (JP); Ariumi Kawamoto, Naruto-shi (JP)

(73) Assignee: TOMITA PHARMACEUTICAL CO., LTD., Naruto-shi (JP)

(21) Appl. No.: 13/277,869

(22) Filed: Oct. 20, 2011

(51) Int. Cl. C01F 5/02; B32B 5/16

(52) U.S. Cl. 428/402

(57) ABSTRACT

Provided is a magnesium oxide for pharmaceutical use that, when mixed with a drug that is unstable in acid, demonstrates high stabilizing effects on the drug while also demonstrating superior stability of the magnesium oxide per se. The magnesium oxide for pharmaceutical use is used by being mixed with a drug that is unstable in acid, and has a specific surface area as determined according to the BET method of 20 m²/g to 200 m²/g and a degree of activation of 40 Img/g to 200 Img/g.

### BACKGROUND OF THE INVENTION

1. Field of the Invention

The present invention relates to a magnesium oxide for pharmaceutical use that is used by being mixed with drugs that are unstable in acid.

2. Description of the Related Art

Pharmaceuticals containing a drug that is unstable in acid in the manner of, for example, benzimidazole-based compounds are susceptible to deterioration over time due to the properties of the drug.

In recognition of this, Japanese Patent No. 3746167 discloses an oral disintegrating tablet comprising fine granules of a composition containing a benzimidazole-based compound unstable in acid, a salt thereof and a basic inorganic salt coated with an enteric coating layer, and a water-soluble sugar-alcohol. Magnesium carbonate, magnesium oxide and magnesium hydroxide are described as examples of the basic inorganic salt.

However, although Japanese Patent No. 3746167 discloses that a basic inorganic salt in the manner of magnesium oxide is incorporated in order to stabilize the benzimidazole-based compound and salt thereof, there is no focus whatsoever placed on the various properties of the basic inorganic salt from the viewpoint of stabilization. As a result, the basic inorganic salt was not necessarily satisfactory with respect to the stabilization of benzimidazole-based compounds and salts thereof.

As a result of focusing on the basic inorganic salt, magnesium oxide, the inventors of the present invention found that by defining specific surface area as determined according to the BET method to be 20 mg²/g to 200 m²/g and defining degree of activation to be 40 Img/g to 200 Img/g, a magnesium oxide for pharmaceutical use can be obtained that demonstrates high drug stabilizing effects even if it is mixed with an unstable drug in acid while also demonstrating superior stability of the magnesium oxide per se.

### SUMMARY OF THE INVENTION

According to the present invention, a magnesium oxide for pharmaceutical use is provided that is used by being mixed with a drug that is unstable in acid, and has a specific surface area as determined according to a BET method of 20 m²/g to 200 m²/g and a degree of activation of 40 Img/g to 200 Img/g.

In addition, the present invention provides a production method of a pharmaceutical that comprises a step for mixing magnesium oxide, having a specific surface area as determined according to the BET method of 20 m²/g to 200 m²/g and a degree of activation of 40 Img/g to 200 Img/g, with a drug that is unstable in acid.

According to the present invention, a magnesium oxide for pharmaceutical use can be provided that demonstrates high drug stabilizing effects when mixed with a drug that is unstable in acid, has superior stability on its own, enables raw material and production costs to be reduced by decreasing the amount mixed with drug, and can be easily taken by a patient since it enables the drug form thereof to be reduced in size.

### DESCRIPTION OF THE PREFERRED EMBODIMENTS

The following provides a detailed explanation of the magnesium oxide for pharmaceutical use according to embodiments of the present invention.

The magnesium oxide for pharmaceutical use according to the embodiments is used by being mixed with a drug that is unstable in acid, and has a specific surface area as determined according to the BET method of 20 m²/g to 200 m²/g and a degree of activation of 40 Img/g to 200 Img/g.

Examples of forms of “mixing with a drug that is unstable in acid” include mixing the magnesium oxide for pharmaceutical use with a drug that is unstable in acid and using the mixture as a tablet, and coating the mixture onto a carrier (core particles) such as crystalline cellulose alone, a sugar alone or a sugar and crystalline cellulose, and using as a tablet. In the case of mixing the magnesium oxide for pharmaceutical use with a drug that is unstable in acid in this manner, since the magnesium oxide for pharmaceutical use according to the embodiments has a high stabilizing effect on the drug, the mixing ratio can be reduced. As a result, raw material and production costs can be reduced, and the resulting pharmaceutical can be taken easily by a patient since the size of the drug form can be reduced.

Examples of drugs used for the drug that is unstable in acid include:

benzimidazole-based compounds and salts thereof such as lansoprazole, omeprazole, rabeprazole, pantoprazole, leminoprazole, tenatoprazole and TU-199;

imidazopyridine-based compounds or salts thereof;

anti-inflammatory enzyme agents in the manner of serrapeptase and semi-alkaline proteinase;

macrolide antibiotics in the manner of erythromycin;

tocopherol succinate or salts thereof in the manner of α-tocopherol, tocopherol calcium succinate, d1-α-tocopherol calcium succinate and d-α-tocopherol calcium succinate;

vitamin B1 or salts thereof such as thiamine inorganic acids or salts thereof in the manner of thiamine hydrochloride, thiamine nitrate and thiamine phosphate, or activated vitamin B1 derivatives or salts thereof in the manner of prosultiamine, fursultiamine, thiamine disulfide, thiamine disulfide phosphate, bisbentiamine, bisbutytiamine and bisibutiamine;

azulene sulfonates in the manner of sodium azulene sulfonate and potassium azulene sulfonate; and,

2-arylpropionic acid derivatives in the manner of ibuprofen, ibuprofen lysine, ketoprofen, flurbiprofen and naproxen.

The above-mentioned “specific surface area determined according to the BET method” and “the degree of activation” refer to values measured according to the methods indicated below.

1) Specific Surface Area Determined According to BET Method

0.1 g of a sample of magnesium oxide powder is measured for specific surface area according to the BET method using the following measuring device and according to the following pretreatment conditions and test conditions.
Measuring device: High-speed specific surface area and pore size distribution analyzer (NOVA 4000e, Yuasa-Ionics Co., Ltd.)
Pretreatment conditions: Holding for 1 hour at 105° C. while degassing
Test conditions: Measuring with the 3-point plot method according to the nitrogen adsorption method

2) Degree of Activation

Carbon tetrachloride is initially added to 13 g of iodine and brought to a total volume of 1000 mL to prepare a 1 N iodine tetrachloride solution. 75 (W/L) % of ethyl alcohol are added to 0.5 g of potassium iodide and brought to a total volume of 100 mL to prepare a 0.03 N potassium iodide solution. In addition, water is added to 13 g of sodium thiosulfate pentahydrate and 0.1 g of anhydrous sodium carbonate and brought to a total volume of 1000 mL to prepare a 0.05 N sodium thiosulfate solution.

2.0 g of the magnesium oxide powder sample and 10 mL of the 1 N iodine carbon tetrachloride solution are placed in a separatory funnel and shaken for 30 minutes followed by allowing to stand for 15 minutes. 20 mL of the supernatant are placed in an Erlenmeyer flask, and 50 mL of the 0.03 N potassium iodide solution are added thereto and mixed followed by titrating with the 0.05 N sodium thiosulfate solution and measuring the titrated amount based on an endpoint of when the color changes from reddish-brown to white.

A blank test in which sample is not added is similarly carried out followed by measurement of the titrated amount of the 0.05 N sodium thiosulfate solution at that time.

The degree of activation is determined by substituting the titrated amount of 0.05 N sodium thiosulfate solution measured in the sample test (V1) and the titrated amount of 0.05 N sodium thiosulfate solution measured in the blank test (V0) into the following equation (1).

Degree of activation(Img/g)={(V1−V0)×127×N}/0.4 (1)

Here, N is a value obtained by multiplying the normality of the sodium thiosulfate solution by a coefficient (factor).

In the magnesium oxide for pharmaceutical use according to the embodiments, if the BET specific surface area and degree of activation respectively deviate from the above-mentioned ranges, it becomes difficult to achieve stabilizing effects on the drug when mixed with a drug that is unstable in acid as well as superior stability of the magnesium oxide per se. The BET specific surface area and degree of activation are more preferably 60 m²/g to 150 m²/g and 60 Img/g to 170 Img/g, respectively, and most preferably 70 m²/g to 150 m²/g and 80 Img/g to 170 Img/g, respectively.

The mean particle diameter of the magnesium oxide for pharmaceutical use according to the embodiments is preferably 0.1 μm to 50 μm. In addition, the bulk density is preferably 0.3 g/mL or more.

Here, “mean particle diameter” and “bulk density” are values measured according to the methods indicated below.

3) Mean Particle Diameter

After dispersing a sample in ethanol and pretreating with an ultrasonic homogenizer, particle size distribution is measured with Microtrac manufactured by Nikkiso Co., Ltd. The particle diameter of the integrated value of 50% by weight as determined by integrating from the particle having the smallest particle size distribution is taken to be the mean particle diameter.

4) Bulk Density
Measuring device: Powder volume reduction analyzer (TPM-7-P) manufactured by Tsutsui Scientific Instruments Co., Ltd.
Test conditions: Tapping for 100 times at a tapping height of 4 cm and tapping speed of 36 times/min.

First, 20 g of a sample of magnesium oxide powder is placed in a 50 mL graduated cylinder followed by placing the graduated cylinder in the above-mentioned measuring device. After testing under the conditions described above, the volume F (mL) is measured visually. Subsequently, bulk density (g/mL) is calculated at 20/F.

The magnesium oxide for pharmaceutical use according to the embodiments can be produced according to, for example, the method described below.

Magnesium oxide for pharmaceutical use having a BET specific surface area of 20 m²/g to 200 m²/g and a degree of activation of 40 Img/g to 200 Img/g can be produced by either firing magnesium hydroxide alone or firing magnesium hydroxide with magnesium carbonate or magnesium chloride followed by mixing, or by mixing magnesium oxide with magnesium carbonate or magnesium chloride followed by firing.

The following provides an explanation of examples of the present invention.

### Example 1

Magnesium Hydroxide NK (trade name, Tomita Pharmaceutical Co., Ltd., mean particle diameter: 49.6 μm, BET specific surface area: 38.4 m²/g, apparent density: 0.54 g/mL) and JP (Japanese pharmacopoeia) grade Light Magnesium Carbonate (trade name, Tomita Pharmaceutical Co., Ltd., mean particle diameter: 4.7 μm, BET specific surface area: 31.2 m²/g, bulk density: 0.18 g/mL) were respectively heated to 600° C. in an air atmosphere, and after firing by holding at this temperature for 2 hours, the former fired product and the latter fired product were mixed at a weight ratio of 1:3 to produce magnesium oxide powder.

### Example 2

Magnesium Hydroxide NK (trade name, Tomita Pharmaceutical Co., Ltd., mean particle diameter: 49.6 μm, BET specific surface area: 38.4 m²/g, apparent density: 0.54 g/mL) and JP (Japanese pharmacopoeia) grade Light Magnesium Carbonate (trade name, Tomita Pharmaceutical Co., Ltd., mean particle diameter: 11.7 μm, BET specific surface area: 21.9 m²/g, bulk density: 0.48 g/mL) were respectively heated to 600° C. in an air atmosphere, and after firing by holding at this temperature for 2 hours, the former fired product and the latter fired product were mixed at a weight ratio of 1:3 to produce magnesium oxide powder.

### Example 3

Light magnesium oxide powder (product of Tomita Pharmaceutical Co., Ltd.) was used.

### Example 4

Magnesium Hydroxide NK (trade name, Tomita Pharmaceutical Co., Ltd., mean particle diameter: 49.6 μm, BET specific surface area: 38.4 m²/g, apparent density: 0.54 g/mL) was heated to 500° C. in an air atmosphere and fired by holding for 1 hour at that temperature to produce magnesium oxide powder.

Specific surface area according to the BET method, degree of activation, mean particle diameter, bulk density, oil absorption and pH were measured for the resulting magnesium oxide powders of Examples 1 to 4. Those results are shown in the following Table 1.

Specific surface area, degree of activation, mean particle diameter and bulk density were measured according to the test methods described in 1) to 4) above. Oil absorption and pH were measured according to the methods described below.

5) Oil Absorption

10 g of a sample of magnesium oxide powder was placed on a black plastic sheet. Boiling linseed oil was dropped onto the sample from a biuret, kneaded with the sample by moving a spatula in small circles, and the amount of linseed oil dropped onto the sample when the entire sample formed a single clump was taken to be the endpoint. Oil absorption was then calculated from the following equation (2).

Oil absorption(mL/g)=V/W (2)

Here, V represents the amount of boiling linseed oil dropped onto the sample (mL), while W represents the weight of the sample (10 g).

6) pH

2 g of a sample of the magnesium oxide powder were suspended in 50 mL of water at room temperature, and the pH of this suspension was measured with a pH meter.

<Evaluation of Magnesium Oxide Powders>

50 g of the magnesium oxide powders of Examples 1 to 4 and 50 g of a magnesium oxide powder of Comparative Example 1 having the BET specific surface area, degree of activation, mean particle diameter, bulk density, oil absorption and pH indicated in the following Table 1 (product name: Starmag P, Konoshima Co., Ltd.) were respectively mixed with 10 g of a drug that is unstable in acid in the form of omeprazole (Union Químico Farmacéutica, S.A.).

A portion of each mixture was placed in an aluminum laminated pouch consisting of polyethylene/aluminum foil/polypropylene and sealed therein followed by placing in refrigerated storage for use as standard samples.

The remainder of each mixture was placed directly in a constant temperature, constant humidity bath and allowed to stand for 7 days under conditions of 40° C. and 75 RT % for use as evaluation samples.

The chromaticity of the resulting standard samples and four types of evaluation samples was measured with a colorimeter (Z-300A, Nippon Denshoku Industries Co., Ltd.) followed by determination of the difference between the chromaticity of the evaluation samples (E1) with respect to the chromaticity of the standard samples (E0) (color difference ΔE: E1−E0). Those results are shown in the following Table 1.

In addition, 50 g of the magnesium oxide powders of Examples 1 to 4 and Comparative Example 1 were respectively mixed with 10 g of a drug that is unstable in acid in the form of rabeprazole (Hetero Labs Ltd.).

Color difference ΔE was determined for each mixture in the same manner as described above. Those results are shown in the following Table 1.

Moreover, 50 g of the magnesium oxide powders of Examples 1 to 4 and Comparative Example 1 were respectively mixed with 10 g of a drug that is unstable in acid in the form of lansoprazole (Union Químico Farmacéutica, S.A.).

Color difference ΔE was determined for each mixture in the same manner as described above. Those results are shown in the following Table 1.

A smaller color difference ΔE in these evaluations indicates lower chromaticity of the evaluation sample, or in other words, less deterioration over time and higher stabilizing effects on drugs unstable in acid.

TABLE 1

| | | | | | Comp. |
|---|---|---|---|---|---|
| | Ex. 1 | Ex. 2 | Ex. 3 | Ex. 4 | Ex. 1 |
| BET specific surface area | 89 | 82 | 63 | 50 | 8 |
| (m²/g) | | | | | |
| Degree of activation (Img/g) | 167 | 110 | 79 | 88 | 6 |
| Mean particle diameter (μm) | 8.9 | 9.3 | 4.4 | 9.6 | 3.9 |
| Bulk density (g/mL) | 0.31 | 0.57 | 0.32 | 0.42 | 0.40 |
| Oil absorption (mL/g) | 0.85 | 0.78 | 0.78 | 0.66 | 0.48 |
| pH (4% suspension) | 11.3 | 11.2 | 11.0 | 11.2 | 11.0 |
| Evaluation: ΔE | | | | | |
| (accelerated, 7 days) | | | | | |
| Omeprazole | 0.39 | 0.31 | 0.85 | 0.86 | 4.18 |
| Rabeprazole | 0.18 | 0.22 | 1.09 | 2.56 | 9.71 |
| Lansoprazole | 0.46 | 0.39 | 1.10 | 0.93 | 1.69 |

As is clear from Table 1, the magnesium oxide powders of Examples 1 to 4, having a BET. specific surface area of 20 m²/g to 200 m²/g and a degree of activation of 40 Img/g to 200 Img/g, were determined to be able to demonstrate smaller values for color difference ΔE and reduce deterioration of drug in an accelerated test under constant temperature and constant humidity conditions when mixed with a drug that is unstable in acid (omeprazole, rabeprazole or lansoprazole) in comparison with the magnesium oxide powder of Comparative Example 1 having a BET specific surface area and a degree of activation of less than 20 m²/g and less than 40 Img/g, respectively.

In particular, the magnesium oxide powders of Examples 1 and 2, which demonstrated BET specific surface areas of 70 m²/g to 150 m²/g and degrees of activation of 80 Img/g to 170 Img/g, were determined to demonstrate even higher stabilizing effects on rabeprazole, which is extremely unstable in acid and demonstrates considerable deterioration.

What is claimed is:

1. A magnesium oxide for pharmaceutical use that is used by being mixed with a drug that is unstable in acid, wherein the magnesium oxide has a specific surface area as determined according to a BET method of 20 m²/g to 200 m²/g and a degree of activation of 40 Img/g to 200 Img/g.

2. The magnesium oxide for pharmaceutical use according to claim 1, wherein the specific surface area as determined according to the BET method is 60 m²/g to 150 m²/g and the degree of activation is 60 Img/g to 170 Img/g.

3. The magnesium oxide for pharmaceutical use according to claim 1, wherein the specific surface area as determined according to the BET method is 70 m²/g to 150 m²/g and the degree of activation is 80 Img/g to 170 Img/g.
